(19) United States
(12) Patent Application Publication
(10) Pub. No.: US 2015/0189608 A1
(43) Pub. Date: Jul. 2, 2015

(54) LTE-Advanced Sample Clock Timing Acquisition

(71) Applicant: Metanoia Communications Inc., Hsinchu (TW)

(72) Inventors: Jeffrey C. Strait, Reno, NV (US); Emanoil Felician Bors, Grass Valley, CA (US)

(73) Assignee: Metanoia Communications Inc., Hsinchu (TW)

(21) Appl. No.: 14/141,630

(22) Filed: Dec. 27, 2013

(51) Int. Cl. H04W 56/00

(52) U.S. Cl. CPC H04W 56/001

(57) ABSTRACT

Various embodiments of techniques related to sample clock timing acquisition are provided. In one aspect, a method includes a first communication device receiving a wireless communication signal from a second communication device. The method also includes detecting a primary synchronization signal in the wireless communication signal. The method further includes estimating, based at least in part on the primary synchronization signal, a frequency offset between a sample clock timing frequency of the first communication device and a sample clock timing frequency of the second communication device.

### BACKGROUND

1. Technical Field

The present disclosure relates to wireless communications and, more specifically, to sample clock timing acquisition in wireless communications.

2. Description Of Related Art

The new 4G wireless technology standard termed Long Term Evolution-Advanced (LTE-A) utilizes the well-known modulation scheme known as orthogonal frequency division multiple access (OFDMA). It is a multicarrier technique in which the transmit spectrum is divided into K orthogonal subcarriers equally spaced in frequency. The method has been used for many years in both wireline broadband communications and wireless local area networks (WLAN). LTE-A provides a minimum of 1000 Mbps throughput in the downlink (DL) and 500 Mbps in the uplink (UL). The spectral bandwidth for LTE-A is 100 MHz, using up to five component carriers each with a component bandwidth of up to 20 MHz. LTE-A also includes support for both frequency domain duplexing and time domain duplexing.

LTE-A also employs multiple antenna methods such as spatial multiplexing and transmit diversity. Spatial multiplexing (SM) is a multiple-input and multiple-output system (MIMO) formulation enabled by configuring multiple antennas separated in space. The spatially separated antennas provide separate and distinct transmission channels allowing the transmitter-receiver pair to extract independent signals from each channel while cancelling interference from the other transmission paths. When combined, OFDMA and MIMO-SM provide orthogonality in both frequency and space. LTE-A supports up to eight antennas per modem. Furthermore, LTE-A uses an advanced error correction coding scheme known as Turbo Coding. This is a channel coding method which utilizes a combination of convolutional coding and pseudo random interleaving. The PN interleaver is positioned between two constituent encoders, resulting in near-Shannon limit coding gain when combined with maximum a-posteriori (MAP) decoding.

### SUMMARY

The present disclosure pertains to a scheme in which an estimate of the sampling clock frequency offset between a base station transmitter and a user equipment (UE) receiver is calculated for sample clock timing acquisition. The frequency offset is used to compensate for actual frequency difference by interpolated timing recovery using a polyphase filter in the receiver.

In one aspect, a method may include: receiving, by a first communication device, a wireless communication signal from a second communication device; detecting a primary synchronization signal in the wireless communication signal; and estimating, based at least in part on the primary synchronization signal, a frequency offset between a sample clock timing frequency of the first communication device and a sample clock timing frequency of the second communication device.

In some embodiments, the detecting the primary synchronization signal may include identifying one or more pairs of peak signals in a radio frame in the wireless communication signal. Each pair of peak signals respectively may include a first peak signal and a second peak signal that exceed a predefined threshold signal level. The first peak signal and the second signal of each pair of peak signals may be separated in time by half of the radio frame.

In some embodiments, the detecting the primary synchronization signal may further include: determining a reference signal that corresponds to the first peak signal of one of the one or more pairs of peak signals to be the primary synchronization signal; and determining a half-frame estimate based at least in part on the reference signal that is determined to be the primary synchronization signal.

In some embodiments, the estimating the frequency offset may include: selecting two peak signals from the one or more pairs of peak signals, the two selected peak signals being adjacent peak signals or being apart from one another by a multiple of one half of the radio frame; and determining a frequency offset ratio using a spacing in time between the two selected peak signals.

In some embodiments, the determining the frequency offset ratio may include determining the frequency offset ratio based at least in part on the following definitions and expressions:
Tᵣₓ=a sampling period at the first communication device;
Tₜₓ=a sampling period at the second communication device;
T_{Δ}=a spacing in time between the two selected peak signals;
fᵣₓ=a sampling frequency at the first communication device=1/Tᵣₓ;
fₜₓ=a sampling frequency at the second communication device=1/Tₜₓ;
Nᵣₓ=a number of samples taken at the first communication device during a time between the two selected peak signals;
Nₜₓ=a number of samples taken at the second communication device during a time between the two selected peak signals;

fₜₓT_{Δ}=Nₜₓ;

fᵣₓT_{Δ}=Nᵣₓ;

Nₜₓ/fₜₓ=Nᵣₓ/fᵣₓ;

fₜₓ/fᵣₓ=Nₜₓ/Nᵣₓ; and

Tₜₓ/Tᵣₓ=Nᵣₓ/Nₜₓ.

In some embodiments, the method may further include synchronizing, by the first communication device, the sample clock timing frequency of the first communication device with the sample clock timing frequency of the second communication device based at least in part on the frequency offset ratio.

In some embodiments, the synchronizing may include adjusting the sampling frequency at the first communication device by a factor fₜₓ/fᵣₓ or Tₜₓ/Tᵣₓ.

In some embodiments, the estimated frequency offset may be expressed as follows:

f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by the first communication device in estimating the frequency offset;
N_{rf}=a number of samples in one radio frame; and
N_{dec}=a decimation ratio used in the detecting of the primary synchronization signal.

In some embodiments, the second communication device may include a base station operating as an evolution node B (eNodeB) in accordance with the LTE standard of a variation thereof.

In some embodiments, the method may further include synchronizing, by the first communication device, the sample clock timing frequency of the first communication device with the sample clock timing frequency of the second communication device based at least in part on the estimated frequency offset.

In another aspect, a communication device may include a receiving unit and a processing unit. The receiving unit may be configured to receive a wireless communication signal from another communication device. The processing unit may be coupled to the receiving unit to process the wireless communication signal. The processing unit may be configured to performing operations including: detecting a primary synchronization signal in the wireless communication signal; and estimating, based at least in part on the primary synchronization signal, a frequency offset between a sample clock timing frequency of the communication device and a sample clock timing frequency of the another communication device.

In some embodiments, in detecting the primary synchronization signal, the processing unit may be configured to identify one or more pairs of peak signals in a radio frame in the wireless communication signal. Each pair of peak signals respectively may include a first peak signal and a second peak signal that exceed a predefined threshold signal level. The first peak signal and the second signal of each pair of peak signals may be separated in time by half of the radio frame.

In some embodiments, in detecting the primary synchronization signal, the processing unit may be configured to further perform operations including: determining a reference signal that corresponds to the first peak signal of one of the one or more pairs of peak signals to be the primary synchronization signal; and determining a half-frame estimate based at least in part on the reference signal that is determined to be the primary synchronization signal.

In some embodiments, in estimating the frequency offset, the processing unit may be configured to perform operations including: selecting two peak signals from the one or more pairs of peak signals, the two selected peak signals being adjacent peak signals or being apart from one another by a multiple of one half of the radio frame; and determining a frequency offset ratio using a spacing in time between the two selected peak signals.

In some embodiments, in determining the frequency offset ratio, the processing unit may be configured to determine the frequency offset ratio based at least in part on the following definitions and expressions:
Tᵣₓ=a sampling period at the communication device;
Tₜₓ=a sampling period at the second communication device;
T_{Δ}=a spacing in time between the two selected peak signals;
fᵣₓ=a sampling frequency at the communication device=1/Tᵣₓ;
fₜₓ=a sampling frequency at the second communication device=1/Tₜₓ;
Nᵣₓ=a number of samples taken at the communication device during a time between the two selected peak signals;
Nₜₓ=a number of samples taken at the second communication device during a time between the two selected peak signals;

fₜₓT_{Δ}=Nₜₓ;

fᵣₓT_{Δ}=Nᵣₓ;

Nₜₓ/fₜₓ=Nᵣₓ/fᵣₓ;

fₜₓ/fᵣₓ=Nₜₓ/Nᵣₓ; and

Tₜₓ/Tᵣₓ=Nᵣₓ/Nₜₓ.

In some embodiments, the processing unit may be configured to synchronize the sample clock timing frequency of the communication device with the sample clock timing frequency of the another communication device based at least in part on the frequency offset ratio.

In some embodiments, in synchronizing, the processing unit may be configured to adjust the sampling frequency at the communication device by a factor fₜₓ/fᵣₓ or Tₜₓ/Tᵣₓ.

In some embodiments, the estimated frequency offset may be expressed as follows:

f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by the communication device in estimating the frequency offset;
Nᵣₜ=a number of samples in one radio frame; and
N_{dec}=a decimation ratio used in the detecting of the primary synchronization signal.

In some embodiments, the receiving unit may be configured to receive the wireless communication signal from the another communication device in accordance with the LTE standard of a variation thereof.

In some embodiments, the processing unit may be further configured to synchronize the sample clock timing frequency of the communication device with the sample clock timing frequency of the another communication device based at least in part on the estimated frequency offset.

This summary is provided to introduce techniques related to LTE-A sample clock timing acquisition. Some embodiments of the technique are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 shows an example system in which embodiments of sample clock timing acquisition may be implemented in accordance with at least some embodiments described herein.

FIG. 2 is a diagram of two types of frame structures defined in the LTE-A standard.

FIG. 3 shows a downlink resource grid defined in the LTE-A standard.

FIG. 4 shows an example processing flow with which sample clock timing acquisition may be implemented in accordance with at least some embodiments described herein.

FIG. 5 shows an example communication device with which sample clock timing acquisition may be implemented in accordance with at least some embodiments described herein.

FIG. 6 shows a block diagram of an example computing device by which various example solutions described herein may be implemented in accordance with at least some embodiments described herein.

### DETAILED DESCRIPTION OF THE PREFERRED EMBODIMENTS

### Overview

An LTE-A sampling frequency offset estimation scheme in accordance with the present disclosure is devised based on a primary synchronization signal (PSS) detection system in which a PSS correlation peak detector output is used to measure the sampling clock frequency error, or offset, between a far-end eNodeB transmitter and a near-end UE receiver. A frequency offset ratio, or equivalently the sample period ratio, is used in a polyphase interpolated timing recovery process in which interpolated sample phases from a polyphase filter are used to synchronize the UE receiver to the transmitted frequency and sample period.

To illustrate the scheme and techniques proposed in the present disclosure, an example implementation of a specific PSS correlation peak detector is described below. The PSS correlation peak detector provides a PSS correlation signal to a frequency offset estimation engine. Separation in PSS correlation peaks provides information on the frequency error between the clock of the eNodeB transmitter and the clock of the UE receiver. It would be appreciated by those skilled in the art that the frequency offset estimation scheme of the present disclosure is also applicable when used with PSS detectors that use different sampling rates, different symbol sizes, and different decimation factors (including no decimation at all).

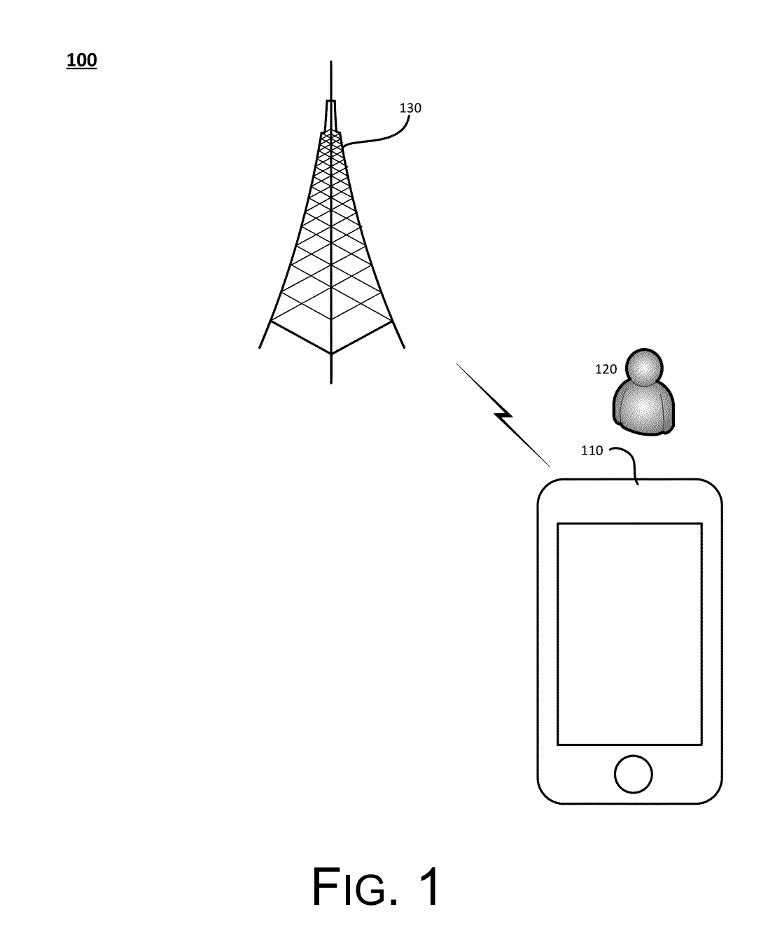

FIG. 1 shows an example system 100 in which embodiments of sample clock timing acquisition may be implemented in accordance with at least some embodiments described herein. As depicted, system 100 includes, at least, a first communication device 110, used, operated or otherwise carried by user 120, and a second communication device 130 that are in wireless communication with one another. For example, first communication device 110 may receive one or more wireless communication signals from second communication device 130. Additionally or alternatively, first communication device 110 may transmit one or more wireless communication signals to second communication device 130. In some embodiments, first communication device 110 may be a user equipment and second communication device 130 may be a base station, or eNodeB, in accordance with the LTE-A standard. First communication device 110 is capable of calculating an estimate of the sampling clock frequency offset between a transmitter of second communication device 130 and a receiver of first communication device 110 for sample clock timing acquisition, in accordance with various embodiments described herein. Although not shown in FIG. 1, system 100 may include additional portable communication devices, similar to first communication device 110, which are in wireless communication with second communication device 130.

### Timing Recovery Using Cell Search and Synchronization Signals

Ordinarily the LTE-A base station, referred to as an eNodeB, is continuously transmitting in the DL direction to and receiving signals in the UL direction from numerous UE terminals simultaneously. Whenever another UE enters the service area or is otherwise activated (for example by powering up) it must search for an active eNodeB, go through a synchronization process, and identify the network in order to establish communication. The 3GPP standard specification contains several signals and messages to facilitate this process. Specifically, LTE-A contains three physical layer signals which are used in order to allow each UE to synchronize to the eNodeB: 1) the primary synchronization signal (PSS), 2) the secondary synchronization signal (SSS), and 3) reference signals. Some of these three signals will be described in some detail in the following section.

The inventive concept of the present disclosure is a technique for acquiring sample clock synchronization by utilizing part of the primary synchronization signal detection mechanism. Specifically, part of the PSS detection block/module in the UE receiver provides a signal that is useful for sample timing acquisition.

### LTE-A Symbol and Resource Structure

As previously mentioned, LTE-A uses OFDMA as the modulation scheme in the DL transmission direction. The UL transmission method is single-carrier OFDMA (SC_OFDMA), also known as DFT-spread OFDMA. The UL transmission scheme will not be covered in the present disclosure as it is not relevant to the problem to be addressed. The DL OFDMA modulation technique utilizes N orthogonal subcarriers with a time-domain symbol length of N+Ncp samples, where Ncp is the length of a cyclic prefix (CP). The CP consists of Ncp samples copied from the end of the length N time-domain symbol and pre-appended in front of the original symbol. The baseband symbol is generated by computing an inverse fast Fourier transform (IFFT) where the frequency domain input consists of N complex quadrature amplitude modulation (QAM) data symbols and the output is N complex time-domain samples. A RF modulator converts the baseband signal to RF by QAM with the RF carrier signal.

After RF down-conversion, the UE receiver recovers the transmitted symbols using a FFT demodulator, reversing the modulation introduced in the eNodeB transmitter.

There are two possible values of OFDMA carrier spacing in LTE-A, 7.5 kHz and 15 kHz. This represents the spacing between each of the N carriers over the entire transmit spectrum. Several different FFT sizes N may be used depending on system configuration, namely: 128, 256, 512, 1024, 2048, 4096 (7.5 kHz carrier spacing). Furthermore, there are three possible sub-symbol modulation specifications, namely: QAM, 16QAM, and 64QAM. QAM transmits two bits per carrier using one of four possible symbols. 16QAM transmits four bits per carrier using one of sixteen possible symbols, and 64QAM transmits six bits per symbol using one of sixty-four possible symbols. The length of the cyclic prefix Ncp is specified in Table 1 as follows:

TABLE 1
OFDM Parameters.

| | |
|---|---|
| Configuration | Cyclic prefix length N_{CP,l} |

| | | |
|---|---|---|
| Normal cyclic prefix | Δf = 15 kHz | 160 for l = 0 |
| | | 144 for l = 1, 2, . . . , 6 |
| Extended cyclic | Δf = 15 kHz | 512 for l = 0, 1, . . . , 5 |
| prefix | Δf = 7.5 kHz | 1024 for l = 0, 1, 2 |

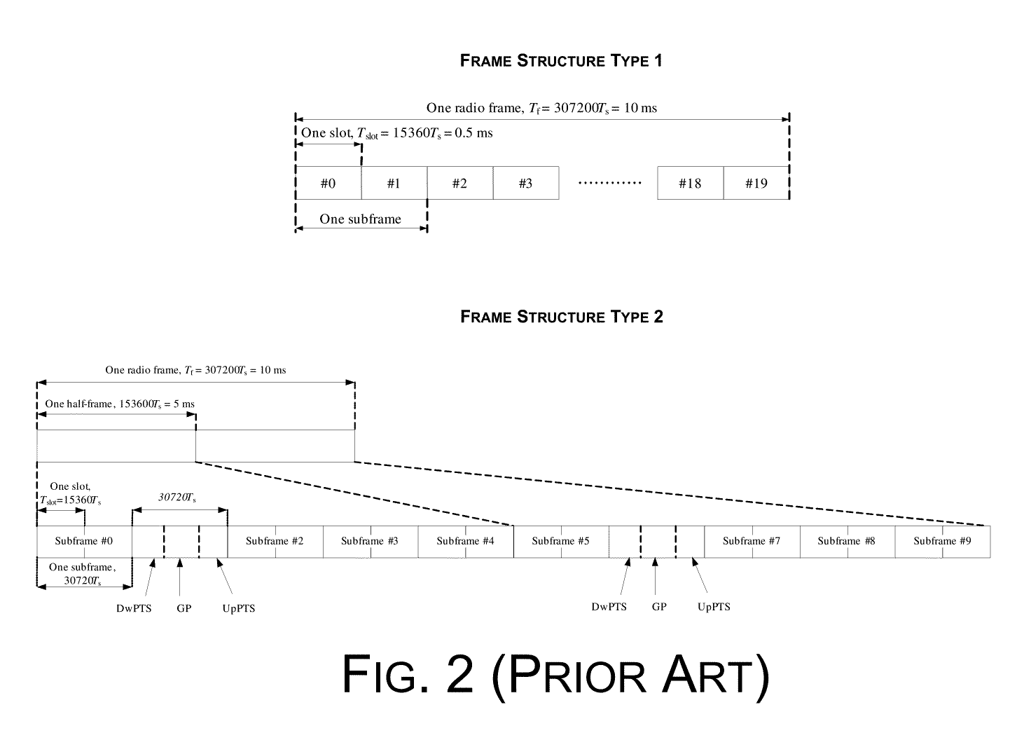

LTE-A specifies a specific radio frame structure. FIG. 2 is a diagram of two types of frame structures defined in the LTE-A standard. One radio frame is a 10 ms interval, which consists of 10 sub-frames with a duration of 1 ms each.

Each subframe is composed of two slots, each with a duration of 0.5 ms. Each slot contains a number of symbols specified as shown in FIG. 2. There are two possible frame structures defined by LTE-A, and they are shown in FIG. 2 as type 1 and type 2. In particular, frame structure type 1 corresponds to frequency domain duplexing (FDD), and frame structure type 2 corresponds to time domain duplexing (TDD).

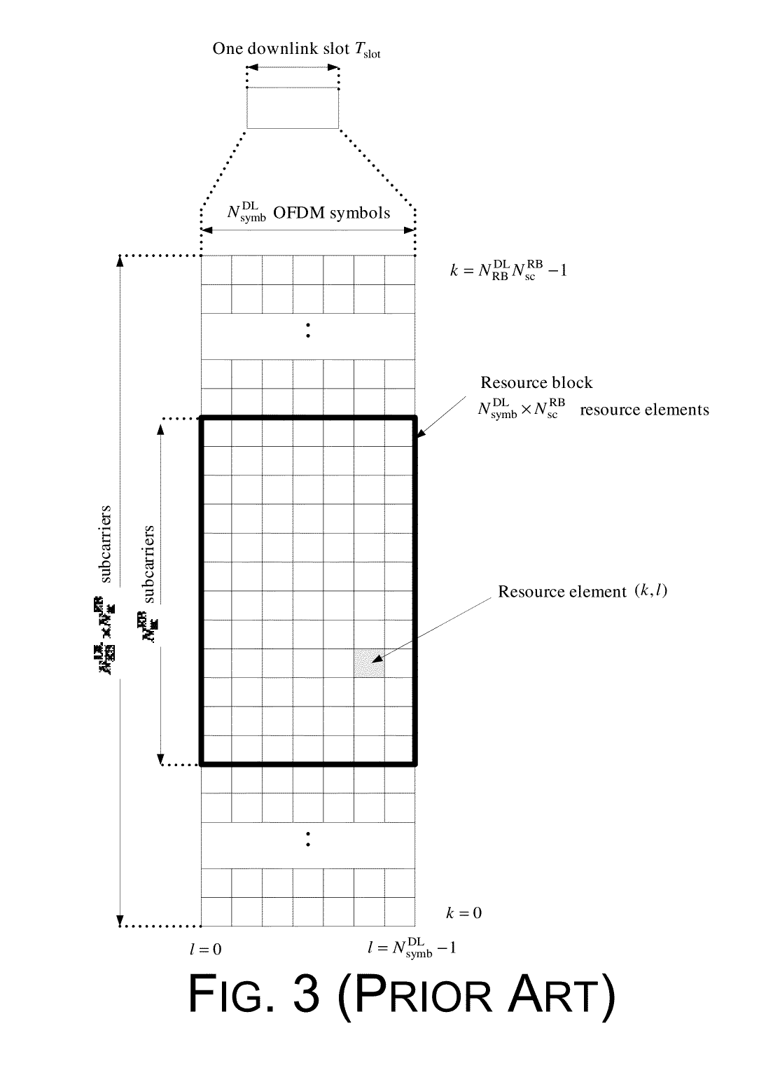

FIG. 3 shows a downlink (DL) resource grid defined in the LTE-A standard. The vertical axis indicates carrier frequency and the horizontal axis indicates symbol number. A resource element (RE) represents one carrier frequency with one symbol duration. A resource block (RB) is typically an array of twelve carriers with duration of seven symbols (or one slot). The RB specification depends on the cyclic prefix selection. Table 2 below shows example DL parameters for physical resource blocks. Here, N_{sc}^{RB} represents the number of subcarriers in one resource block, and N_{RB}^{DL} represents the number of resource blocks in the downlink channel spanning the available bandwidth. As shown in FIG. 3, a resource grid is defined in order to facilitate signal transmission and coherent detection. The resource grid is defined over all N carriers in the transit spectrum and over symbol time in the other direction. The DL resource grid is defined in terms of resource elements and resource blocks specified as N_{RB}^{DL}N_{sc}^{RB} subcarriers and N_{symb}^{DL} OFDM symbols, where N_{RB}^{DL} is the number of resource blocks in the DL and N_{sc}_{RB} the number of subcarriers per resource block. N_{symb}^{DL} is the number of symbols in a resource block, corresponding to one slot (½ sub-frame). With one resource element defined to consist of one carrier with a duration of one symbol, a resource block consists of N_{RB}^{DL}N_{sc}^{RB}×N_{symb}^{DL} resource elements.

TABLE 2
Physical Resource Blocks Parameters (DL)

| | | |
|---|---|---|
| Configuration | N_{sc}^{RB} | N_{symb}^{DL} |

| | | | |
|---|---|---|---|
| Normal cyclic prefix | Δf = 15 kHz | 12 | 7 |
| Extended cyclic prefix | Δf = 15 kHz | | 6 |
| | Δf = 7.5 kHz | 24 | 3 |

Considering that LTE-A is a multi-antenna MIMO processing system, the resource grid definition from above exists on the transmit signal for each antenna. LTE-A is a variable bandwidth system in which the width of the transmit spectrum varies with the number of carriers and FFT size. As the FFT size is increased, the bandwidth grows out from the direct current (DC) component in a symmetrical fashion so that the DC carrier is always at the center of the system bandwidth. Both the PSS and SSS occupy carriers in a block of 62 carriers centered in the middle of the frequency band. The PSS is placed in the last symbol of slots 0 and 10 (slots numbered 0-19) and therefore separated by ½ radio frame. Each cell is associated with a cell ID. There are 504 unique physical-layer cell identities given by the following:

N_{ID}^{cell}=3N_{ID}⁽¹⁾+N_{ID}⁽²⁾
N_{ID}⁽¹⁾ is in the range of 0 to 167
N_{ID}⁽²⁾ is in the range of 0 to 2

There are three different PSS sequences depending on N_{ID}⁽²⁾.

Thus, PSS detection provides the following:

1) Symbol boundary alignment;

2) Half frame synchronization;

3) Partial cell identification;

4) Adjacent cell monitoring; and

5) 62 carrier FEQ reference for SSS detection.

The sequence d(n) used for the primary synchronization signal is generated from a frequency-domain Zadoff-Chu sequence according to the following expression:

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix}$$

where the Zadoff-Chu root sequence index u is given by Table 3 below.

TABLE 3
Root Indices for Primary Synchronization Signal

| N_{ID}⁽²⁾ | Root index u |
|---|---|
| 0 | 25 |
| 1 | 29 |
| 2 | 34 |

The sequence d(n) shall be mapped to the resource elements according to the following:

$${a}_{k , l} = d ( n ) , n = 0 , … , 61$$

$$k = n - 31 + \frac{{N}_{RB}^{DL} {N}_{sc}^{RB}}{2}$$

For frame structure type 1, the primary synchronization signal shall be mapped to the last OFDM symbol in slots 0 and 10.

In summary, the primary synchronization signal can be characterized as follows:
Occupies 62 carriers centered in the middle of the frequency band;
Placed in the last symbol of slots 0 and 10 (slots numbered 0-19); and
Separated by ½ radio frame.

### LTE-A Timing Recovery Using PSS Detection

In one embodiment, a PSS detector in accordance with the present disclosure contains several functional blocks that perform various functions listed below in an order from the perspective of the UE receiver signal from the FIFO at the front end of the RX path:
1) Low pass filter/decimate to 64 sample symbol size (32:1 for a 2048 sample symbol);
2) Enumerate correlation with 3 possible reference primary synchronization signals;
3) Sum the signals from all antennas, process all the antennas independently and concurrently, or cycle through all of them one at a time; and
4) Detect winner and capture symbol alignment and half frame synchronization.

PSS detection allows the receiver to compute FEQ taps over the 62 sub-carriers centered at DC. This allows frequency domain detection of SSS.

As soon as the PSS is detected, the peak detection output signal corresponding to the winning reference signal can be used to measure the frequency offset between the far end sample clock timing frequency and the local sample clock timing frequency. The frequency offset is then used in a polyphase interpolated timing module or process in order to synchronize the two sample clocks. A polyphase filter is used to implement the operations of zero-insertion, low pass filtering, and decimation all in one stage. In one embodiment, the polyphase filter is a low pass decimation filter with a cut-off frequency set to 1 /Nₘᵣ, where Nₘᵣ is the interpolation and decimation factor. Because interpolation ordinarily requires zero insertion between adjacent samples, the low pass filter is simply segregated into Nₘᵣ phases with the realization that multiplications are not required where input signal samples are set to zero. Furthermore, polyphase output samples are only required for those points adjacent to the targeted interpolation point as required for the calculation.

This allows the designer to change the sample period via sub-sample interpolation. The sub-sample resolution is determined by the interpolation factor and the number of filter phases. The polyphase samples can be further interpolated using some form of polynomial interpolation, with simple linear interpolation being one common method. In general, the sample clocks at the transmitter and receiver will be close to one another so that the frequency error is very small. The subsequent adjustments made by the polyphase interpolator will be very close to unity.

### Example PSS Detection

The structural block diagram of the system depends on the design approach. There are several possible methods that can be used to examine the signals at the front end of the UE receiver. The signals from the UE receiver antennas can 1) all be examined independently; 2) be examined sequentially and one at a time; or 3) be summed together and analyzed using a single detector. Furthermore, the decimation filtering can be done using either time domain filtering or a frequency domain processing, with the time domain scheme considered here. For the case where the signals are summed together, the summation can be done before the decimation, reducing the complexity of the implementation. For the other possible case, there are one or more detector paths, and the signals from each antenna are decimated then analyzed using a correlation scheme.

For the case where the signals from all the antennas are summed, the operation is simple sample-by-sample addition and is self-explanatory. The other block or components of the system will be explained in detail. The bandwidth around each component carrier is configurable with the FFT size varying from 128 points to 2048 points (for the 15 kHz carrier spacing option). Therefore, the decimation specification must vary from 128:64 to 2048:64 (or 2:1 to 32:1) in order to generate the 64 point center band signal. The time domain decimation operation is well known to those skilled in the art of communications signal processing and consists of a low pass filter with a cut-off frequency set at the decimation rate with output samples calculated at the reduced sampling rate. For example, in order to decimate at a rate of 2:1, the low pass filter cut-off frequency is set to 1/2 where the Nyquist rate is assumed normalized to 1. The output sample of the decimation filter is calculated every other sample to generate a half-rate signal.

The decimated signals are then used as input signals to one or more correlation engines, which calculate the correlation between the inputs and the three possible known reference signals. Correlation engines, procedures, and realizations are again well-known to those skilled in the art of communications signal processing. It is assumed that a commonly understood realization of this engine using either time-domain techniques or frequency domain techniques along with either a hardware realization or a software realization is present.

The PSS detection logic follows using the output signals from one or more correlation engines. The correlation output produces an estimate of the channel impulse response, with additive noise of course, whenever the correct reference signal is used in the correlation function. This is a well-known result from stochastic signal processing theory. Namely, for a linear system, given an input signal and a transmission path impulse response, the correlation of the input signal with the system output signal gives an estimate of the impulse response. If the incorrect reference signal is used, then there is no correlation between the output of the correlation operation and the candidate reference signal. The purpose of the detection logic is to analyze the correlation output signal and discern whether or not the signal represents a reasonable estimate of a transmission path impulse response. If the signal represents a reasonable estimate of a transmission path impulse response, a decision is made that the candidate reference signal was transmitted by the eNodeB transmitter, and an estimate of the symbol boundary is calculated along with half frame synchronization.

In one embodiment, a proposed PSS detection module first searches the radio frame for the peak signal level. An example Matlab code which implements this function is as follows:

```
% Peak detection
DetectResult = [ ];
PssPeakDetIndex = 0;
PssPeakLevel = 0;
for Index=1 :length(CorrDetectOut)
    if CorrDetectOut(Index) > PssPeakLevel
        PssPeakDetIndex = Index;
        PssPeakLevel = CorrDetectOut(Index);
    end
end
```

Here, CorrDetectOut( ) is the correlation operation output signal for one of the candidate reference signals. The code produces both the signal peak, PssPeakLevel( ) as well as the index within the frame pointing to the peak, PssPeakDetIndex( ). The detector must then search for an accompanying signal peak at or near the peak level identified by the previous operation, within a certain allowable tolerance which can be tuned by the designer based on system noise levels, and that accompanying peak must be separated in time by one half frame, again within a tunable tolerance specified by the designer. An example Matlab code implementing the algorithm is as follows:

```
% Find both PSS symbols in the frame
for Index=1 :length(CorrDetectOut)
    if CorrDetectOut(Index) > PssDetThreshold*PssPeakLevel
        if (CorrDetectOut(Index) > CorrDetectOut(Index−1)) &
                  (CorrDetectOut(Index) >
CorrDetectOut(Index+1))
            DetectResult = [DetectResult;Index];
        end
    end
end
```

The variable PssDetThreshold is the tunable threshold parameter which specifies a minimum detection level in order to identify the second peak in the frame. DetectResult is an array which hold the index pointers to signal peaks, within the specified tolerance, contained in the frame.

The next step is to determine which, if any, of the primary synchronization signals was sent. The following example code may be executed using the peak detection results from the previous stage:

```
% Initialize PSS detector decision
Nid2RX = −1;
% Decide which PSS was transmitted - first test for Nid2=0
for Index=1 :length(DetectResult)−1
    if length(DetectResult)>1
        if (DetectResult(Index+1)−
                  DetectResult(Index)<NumFrameSamplesDown/2
                                    +PeakDetWinSize/2)
            if (DetectResult(Index+1)−
                    DetectResult(Index)>NumFrameSamplesDown/2−
```

PeakDetWinSize/2)

fprintf(1,‘%s%d%s\n’,‘Primary Sync Signal Nid2 =

’,0,‘detected’);

```
                DetectResult;
                Nid2RX = 0;
            end
        end
    end
end
```

The variable PeakDetWinSize is designer tunable to specify an allowable tolerance window of samples about the half frame spacing in which the two peaks in a frames must be located. In the event that more than one reference signal is identified by this process, a tie breaker is proposed that simply calculates the peak signal to noise ratio for each correlation output signal declaring the winner to be the correlator with the highest result. The reason for this is that it is possible for a random signal to contain two peaks which satisfy the detection criterion. However, if a reference signal is contained in the transmission, legitimate detection would show a large peak to noise ratio. If the variable Nid2RX survives the test for all three reference signals while maintaining the initialization value of −1, then the detector failed to identify an LTE-A transmission.

Once the winning candidate reference signal is identified, if present at all, then the symbol and half frame estimates are available by taking the index values as pointers. Furthermore, the now known reference signal provides a frequency domain reference signal that can be used to directly calculate frequency domain equalizer tap values for the carriers used to transmit the PSS.

### Sample Clock Timing Acquisition

An example frequency offset estimation system in accordance with the present disclosure uses PSS signal peaks derived from a PSS detector, either from adjacent PSS peaks or PSS peaks separated by some multiple of the one-half radio frame spacing of the two PSS peaks within a single radio frame. It is possible to improve the resolution of the frequency offset estimate by increasing the spacing between PSS peaks used for the calculation.

The following terms are defined herein:
Tᵣₓ=the sampling period at the receiver
Tₜₓ=the sampling period at the far end transmitter
T_{Δ}=the time between measured PSS correlation peaks
fᵣₓ=the sampling frequency at the receiver=1/Tᵣₓ
fₜₓ=the sampling frequency at the far end transmitter=1/Tₜₓ
Nᵣₓ=the number of samples between measured PSS correlation peaks at the receiver
Nₜₓ=the number of samples between measured PSS correlation peaks at the transmitter

### Then,

fₜₓT_{Δ}=Nₜₓ and fᵣₓT_{Δ}=Nᵣₓ

which gives

Nₜₓ/fₜₓ=Nᵣₓ/fᵣₓ

or

fₜₓ/fᵣₓ=Nₜₓ/Nᵣₓ

In term of the sample periods:

Tₜₓ/Tᵣₓ=Nᵣₓ/Nₜₓ

A polyphase interpolation system in accordance with the present disclosure operates on the sampled input signal with sampling frequency frx and scales it by fₜₓ/fᵣₓ. This is realized by changing the input sampling period Tᵣₓ by the factor Tₜₓ/Tᵣₓ.

In terms of LTE system variables, the frequency offset ratio estimate can be expressed as f_{offset}=(Nᵣₓ−Nₜₓ)/Nₜₓ where Nₜₓ=(Nₚₛₛ*N_{rf})/(2*N_{dec}). Nₚₛₛ indicates the number of PSS peaks spanned by the calculation. N_{rf} is the number of samples in one radio frame. N_{dec} is the decimation ratio used in the PSS detection block. The frequency offset estimate can be expressed in parts per million by multiplying 1×106×f_{offset}.

The following is an example for illustrative purpose and not intended to limit the scope of the inventive concept of the present disclosure. Using a 2048 point FFT size, the normal CP configuration, and FDD, the number of samples in a radio frame is N_{rf}=(7*2048+160+6*144)*20=307200 samples. The decimation ratio in the PSS detection is 32:1. The number of peaks spanned by the calculation is Nₚₛₛ=100. It is found that the number of samples separating the peaks used in the calculation is 480050, while the expected number using the same sample clock timing at the far end transmitter is 480000 samples. Therefore, Nᵣₓ−Nₜₓ=480050−480000=50 samples. The frequency offset ratio is f_{offset}=(50/480000)=1.04167×10⁻⁴. Alternatively, it is 104.167 PPM.

In the example, the UE sampling frequency is too high, resulting in 50 extra samples over the time period which separates the PSS peaks under examination. Therefore the polyphase interpolation block should extend the sample period by the factor 480050/480000 or 1.000104167. The method of polyphase re-sampling to compensate for a frequency sampling error between two signals is well understood and explained in standard text books. The present disclosure calculates the sampling frequency or sampling period adjustment used by the polyphase re-sampling structure previously summarized in the present disclosure.

The above example is presented for a specific PSS detection design, and the proposed technique/scheme of the present disclosure is not limited to work with the design parameters presented above. For example, the same technique can be used for various LTE symbol sizes with varying levels of decimation (including no decimation at all) prior to the correlation calculation with candidate PSS symbols. Also, a varied number of symbol can be used in order to increase the spacing between peaks used for the calculation, which improves the resolution of the calculation.

### Example Process

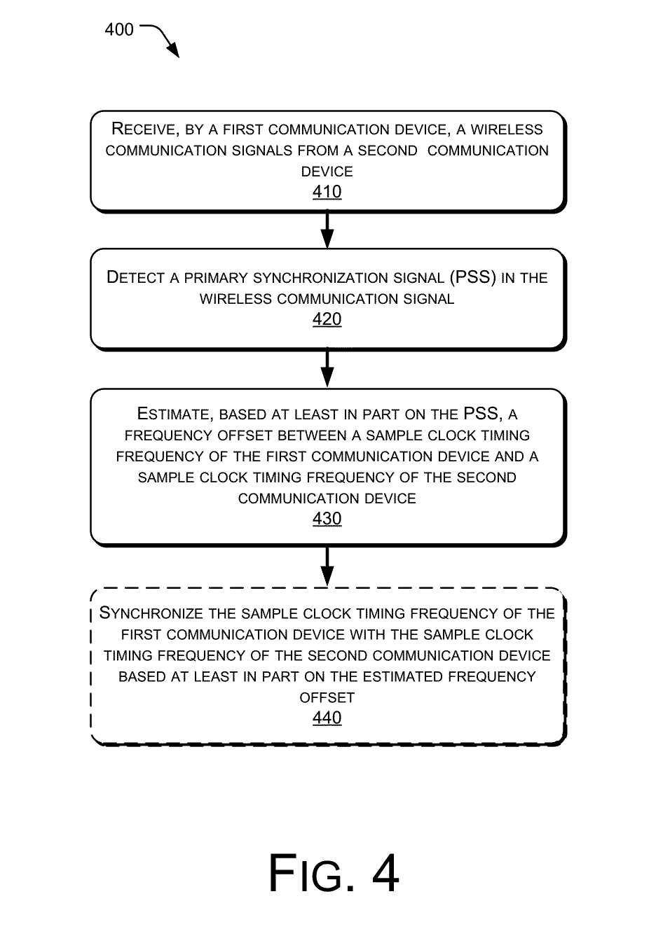

FIG. 4 shows an example processing flow 400 with which sample clock timing acquisition may be implemented in accordance with at least some embodiments described herein. Processing flow 400 may be implemented by first communication device 110 in the context of system 100 of FIG. 1. Further, processing flow 400 may include one or more operations, actions, or functions depicted by one or more blocks 410, 420 and 430. Although illustrated as discrete blocks, various blocks may be divided into additional blocks, combined into fewer blocks, or eliminated, depending on the desired implementation. Processing flow 400 may begin at block 410.

At block 410, processing flow 400 may refer to first communication device 110 receiving a wireless communication signal from second communication device 130. Block 410 may be followed by block 420.

At block 420, processing flow 400 may refer to first communication device 110 detecting a primary synchronization signal in the wireless communication signal. Block 420 may be followed by block 430

At bloc, 430, processing flow 400 may refer to first communication device 110 estimating, based at least in part on the primary synchronization signal, a frequency offset between a sample clock timing frequency of first communication device 110 and a sample clock timing frequency of second communication device 130. Optionally, block 430 may be followed by bloc, 440.

At bloc, 440, processing flow 400 may further include synchronizing, by first communication device 110, the sample clock timing frequency of first communication device 110 with the sample clock timing frequency of second communication device 130 based at least in part on the estimated frequency offset.

In some embodiments, the detecting the primary synchronization signal may include identifying, by first communication device 110, one or more pairs of peak signals in a radio frame in the wireless communication signal. Each pair of peak signals respectively may include a first peak signal and a second peak signal that exceed a predefined threshold signal level. The first peak signal and the second signal of each pair of peak signals may be separated in time by half of the radio frame.

In some embodiments, the detecting the primary synchronization signal may further include: determining, by first communication device 110, a reference signal that corresponds to the first peak signal of one of the one or more pairs of peak signals to be the primary synchronization signal; and determining, by first communication device 110, a half-frame estimate based at least in part on the reference signal that is determined to be the primary synchronization signal.

In some embodiments, the estimating the frequency offset may include: selecting, by first communication device 110, two peak signals from the one or more pairs of peak signals, the two selected peak signals being adjacent peak signals or being apart from one another by a multiple of one half of the radio frame; and determining, by first communication device 110, a frequency offset ratio using a spacing in time between the two selected peak signals.

In some embodiments, the determining the frequency offset ratio may include determining, by first communication device 110, the frequency offset ratio based at least in part on the following definitions and expressions:
Tᵣₓ=a sampling period at the first communication device;
Tₜₓ=a sampling period at the second communication device;
T_{Δ}=a spacing in time between the two selected peak signals;
fᵣₓ=a sampling frequency at the first communication device=1/Tᵣₓ;
fₜₓ=a sampling frequency at the second communication device=1/Tₜₓ;
Nᵣₓ=a number of samples taken at the first communication device during a time between the two selected peak signals;
Nₜₓ=a number of samples taken at the second communication device during a time between the two selected peak signals;

fₜₓT_{Δ}=Nₜₓ;

fᵣₓT_{Δ}=Nᵣₓ;

Nₜₓ/fₜₓ=Nᵣₓ/fᵣₓ;

fₜₓ/fᵣₓ=Nₜₓ/Nᵣₓ; and

Tₜₓ/Tᵣₓ=Nᵣₓ/Nₜₓ.

In some embodiments, processing flow 400 may further include synchronizing, by first communication device 110, the sample clock timing frequency of first communication device 110 with the sample clock timing frequency of second communication device 130 based at least in part on the frequency offset ratio.

In some embodiments, the synchronizing may include adjusting the sampling frequency at first communication device 110 by a factor fₜₓ/fᵣₓ or Tₜₓ/Tᵣₓ.

In some embodiments, the estimated frequency offset may be expressed as follows:

f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by the first communication device in estimating the frequency offset;
N_{rf}=a number of samples in one radio frame; and
N_{dec}=a decimation ratio used in the detecting of the primary synchronization signal.

In some embodiments, second communication device 130 may include a base station operating as an eNodeB in accordance with the LTE standard of a variation thereof, e.g., LTE-A.

### Example Device

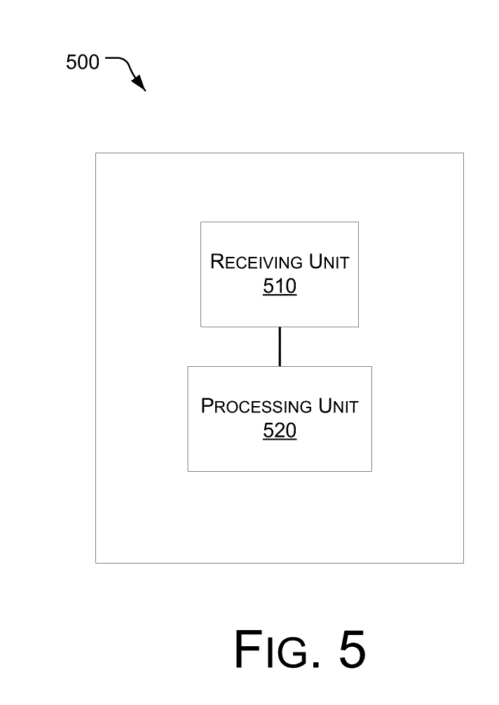

FIG. 5 shows an example communication device 500 with which sample clock timing acquisition may be implemented in accordance with at least some embodiments described herein. Communication device 500 may be an example implementation of first communication device 110 of FIG. 1. Communication device 500 may include a receiving unit 510 and a processing unit 520. Receiving unit 510 may be configured to receive a wireless communication signal from another communication device, e.g., second communication device 130. Processing unit 520 may be coupled to receiving unit 510 to process the wireless communication signal. Processing unit 520 may be configured to performing operations including: detecting a primary synchronization signal in the wireless communication signal; and estimating, based at least in part on the primary synchronization signal, a frequency offset between a sample clock timing frequency of the communication device and a sample clock timing frequency of the another communication device.

In some embodiments, in detecting the primary synchronization signal, processing unit 520 may be configured to identify one or more pairs of peak signals in a radio frame in the wireless communication signal. Each pair of peak signals respectively may include a first peak signal and a second peak signal that exceed a predefined threshold signal level. The first peak signal and the second signal of each pair of peak signals may be separated in time by half of the radio frame.

In some embodiments, in detecting the primary synchronization signal, processing unit 520 may be configured to further perform operations including: determining a reference signal that corresponds to the first peak signal of one of the one or more pairs of peak signals to be the primary synchronization signal; and determining a half-frame estimate based at least in part on the reference signal that is determined to be the primary synchronization signal.

In some embodiments, in estimating the frequency offset, processing unit 520 may be configured to perform operations including: selecting two peak signals from the one or more pairs of peak signals, the two selected peak signals being adjacent peak signals or being apart from one another by a multiple of one half of the radio frame; and determining a frequency offset ratio using a spacing in time between the two selected peak signals.

In some embodiments, in determining the frequency offset ratio, processing unit 520 may be configured to determine the frequency offset ratio based at least in part on the following definitions and expressions:
Tᵣₓ=a sampling period at communication device 500;
Tₜₓ=a sampling period at the second communication device;
T_{Δ}=a spacing in time between the two selected peak signals;
fᵣₓ=a sampling frequency at communication device 500=1/Tᵣₓ;
fₜₓ=a sampling frequency at the second communication device=1/Tₜₓ;
Nᵣₓ=a number of samples taken at communication device 500 during a time between the two selected peak signals;
Nₜₓ=a number of samples taken at the second communication device during a time between the two selected peak signals;

fₜₓT_{Δ}=Nₜₓ;

fᵣₓT_{Δ}=Nᵣₓ;

Nₜₓ/fₜₓ=Nᵣₓ/fᵣₓ;

fₜₓ/fᵣₓ=Nₜₓ/Nᵣₓ; and

Tₜₓ/Tᵣₓ=Nᵣₓ/Nₜₓ.

In some embodiments, processing unit 520 may be configured to synchronize the sample clock timing frequency of communication device 500 with the sample clock timing frequency of the another communication device based at least in part on the frequency offset ratio.

In some embodiments, in synchronizing, processing unit 520 may be configured to adjust the sampling frequency at communication device 500 by a factor fₜₓ/fᵣₓ or Tₜₓ/Tᵣₓ.

In some embodiments, the estimated frequency offset may be expressed as follows:

f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by communication device 500 in estimating the frequency offset;
N_{rf}=a number of samples in one radio frame; and
N_{dec}=a decimation ratio used in the detecting of the primary synchronization signal.

In some embodiments, receiving unit 510 may be configured to receive the wireless communication signal from the another communication device in accordance with the LTE standard of a variation thereof.

In some embodiments, processing unit 520 may be further configured to synchronize the sample clock timing frequency of communication device 500 with the sample clock timing frequency of the another communication device based at least in part on the estimated frequency offset.

### Example Computing Device

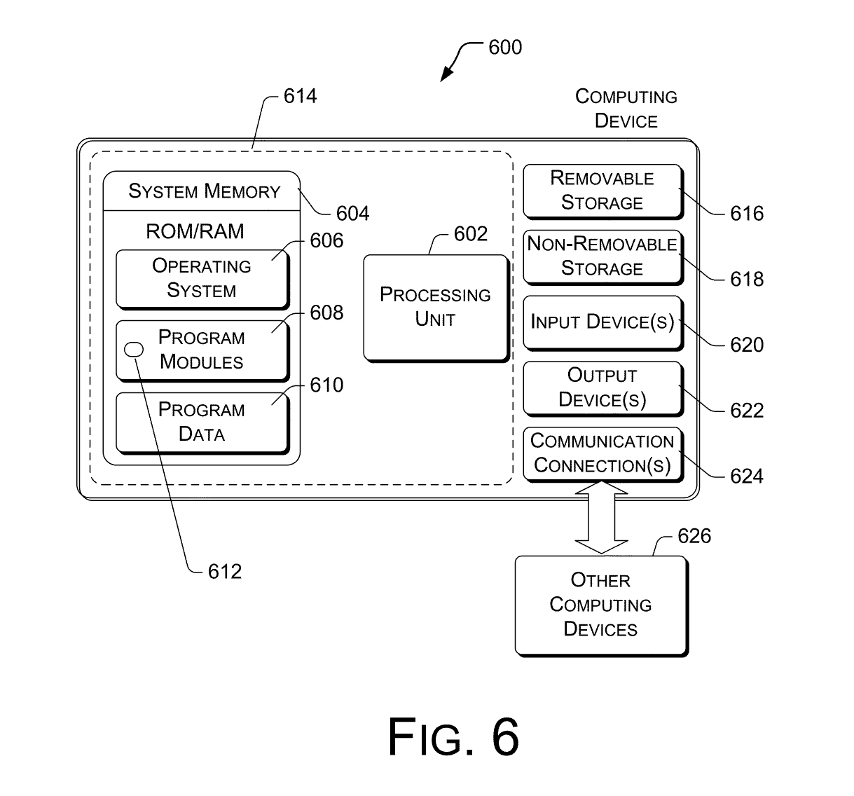

FIG. 6 shows a block diagram of an example computing device 600 by which various example solutions described herein may be implemented, arranged in accordance with at least some embodiments described herein. However, it will be readily appreciated that the techniques disclosed herein may be implemented in other computing devices, systems, and environments. The computing device 600 shown in FIG. 6 is only one example of a computing device and is not intended to suggest any limitation as to the scope of use or functionality of the computer and network architectures.

In at least one configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination thereof. System memory 604 may include an operating system 606, one or more program modules 608, and may include program data 610. Computing device 600 is of a very basic configuration demarcated by a dashed line 614. Again, a terminal may have fewer components but may interact with a computing device that may have such a basic configuration.

In some embodiments, program module 608 includes a sample clock timing acquisition module 612. The sample clock timing acquisition module 612 can carry out one or more functionalities and operations as described above with reference to FIG. 4. For example, when sample clock timing acquisition module 612 is properly configured, computing device 600 can carry out the operations of processing flow 400 as well as variations thereof.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 616 and non-removable storage 618. Computer-readable storage media may include non-transitory volatile and nonvolatile, removable and non-removable media implemented in any method or technology for storage of information, such as computer-executable instructions, data structures, program modules, or other data. System memory 604, removable storage 616 and non-removable storage 618 are all examples of computer storage media. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by computing device 600. Any such computer storage media may be part of the computing device 600. Computing device 600 may also have input device(s) 620 such as keyboard, mouse, pen, voice input device, touch input device, etc. Output device(s) 622 such as a display, speakers, printer, etc. may also be included.

Computing device 600 may further contain communication connections 624 that allow the device to communicate with other computing devices 626, such as over a network. These networks may include wired networks as well as wireless networks. Communication connections 624 are some examples of communication media. Communication media may typically be embodied by computer readable instructions, data structures, program modules, etc.

It is appreciated that the illustrated computing device 600 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, and/or the like.

### Additional and Alternative Implementation Notes

The above-described techniques pertain to sample clock timing acquisition. Although the techniques have been described in language specific to structural features and/or methodological acts, it is to be understood that the appended claims are not necessarily limited to the specific features or acts described. Rather, the specific features and acts are disclosed as example forms of implementing such techniques. Those skilled in the art may make derivations and/or modifications of any of the disclosed embodiments or any variations thereof, and such derivations and modifications are still within the scope of the present disclosure.

In the above description of example implementations, for purposes of explanation, specific numbers, materials configurations, and other details are set forth in order to better explain the invention, as claimed. However, it will be apparent to one skilled in the art that the claimed invention may be practiced using different details than the example ones described herein. In other instances, well-known features are omitted or simplified to clarify the description of the example implementations.

The inventors intend the described embodiments to be primarily examples. The inventors do not intend these embodiments to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques,” for instance, may refer to one or more devices, apparatuses, systems, methods, articles of manufacture, and/or computer-readable instructions as indicated by the context described herein.

As used in the present disclosure, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

What is claimed is:

1. A method, comprising:
receiving, by a first communication device, a wireless communication signal from a second communication device;
detecting a primary synchronization signal in the wireless communication signal; and
estimating, based at least in part on the primary synchronization signal, a frequency offset between a sample clock timing frequency of the first communication device and a sample clock timing frequency of the second communication device.

2. The method of claim 1, wherein the detecting the primary synchronization signal comprises:
identifying one or more pairs of peak signals in a radio frame in the wireless communication signal, each pair of peak signals respectively having a first peak signal and a second peak signal that exceed a predefined threshold signal level, the first peak signal and the second signal of each pair of peak signals being separated in time by half of the radio frame.

3. The method of claim 2, wherein the detecting the primary synchronization signal further comprises:
determining a reference signal that corresponds to the first peak signal of one of the one or more pairs of peak signals to be the primary synchronization signal; and
determining a half-frame estimate based at least in part on the reference signal that is determined to be the primary synchronization signal.

4. The method of claim 2, wherein the estimating the frequency offset comprises:
selecting two peak signals from the one or more pairs of peak signals, the two selected peak signals being adjacent peak signals or being apart from one another by a multiple of one half of the radio frame; and
determining a frequency offset ratio using a spacing in time between the two selected peak signals.

5. The method of claim 4, wherein the determining the frequency offset ratio comprises determining the frequency offset ratio based at least in part on the following definitions and expressions:
Tᵣₓ=a sampling period at the first communication device;
Tₜₓ=a sampling period at the second communication device;
T_{Δ}=a spacing in time between the two selected peak signals;
fᵣₓ=a sampling frequency at the first communication device=1/Tᵣₓ;
fₜₓ=a sampling frequency at the second communication device=1/Tₜₓ;
Nᵣₓ=a number of samples taken at the first communication device during a time between the two selected peak signals;
Nₜₓ=a number of samples taken at the second communication device during a time between the two selected peak signals;
fₜₓT_{Δ}=Nₜₓ;
fᵣₓT_{Δ}=Nᵣₓ;
Nₜₓ/fₜₓ=Nᵣₓ/fᵣₓ;
fₜₓ/fᵣₓ=Nₜₓ/Nᵣₓ; and
Tₜₓ/Tᵣₓ=Nᵣₓ/Nₜₓ.

6. The method of claim 5, further comprising:
synchronizing, by the first communication device, the sample clock timing frequency of the first communication device with the sample clock timing frequency of the second communication device based at least in part on the frequency offset ratio.

7. The method of claim 6, wherein the synchronizing comprises adjusting the sampling frequency at the first communication device by a factor fₜₓ/fᵣₓ or Tₜₓ/Tᵣₓ.

8. The method of claim 5, wherein the estimated frequency offset is expressed as follows:
f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by the first communication device in estimating the frequency offset;
N_{rf}=a number of samples in one radio frame; and
N_{dec}=a decimation ratio used in the detecting of the primary synchronization signal.

9. The method of claim 1, wherein the second communication device comprises a base station operating as an evolution node B (eNodeB) in accordance with the Long-Term Evolution (LTE) standard of a variation thereof.

10. The method of claim 1, further comprising:
synchronizing, by the first communication device, the sample clock timing frequency of the first communication device with the sample clock timing frequency of the second communication device based at least in part on the estimated frequency offset.

11. A communication device, comprising:
a receiving unit configured to receive a wireless communication signal from another communication device; and
a processing unit coupled to the receiving unit to process the wireless communication signal, the processing unit configured to performing operations comprising:
detecting a primary synchronization signal in the wireless communication signal; and
estimating, based at least in part on the primary synchronization signal, a frequency offset between a sample clock timing frequency of the communication device and a sample clock timing frequency of the another communication device.

12. The communication device of claim 11, wherein, in detecting the primary synchronization signal, the processing unit is configured to perform operations comprising:
identifying one or more pairs of peak signals in a radio frame in the wireless communication signal, each pair of peak signals respectively having a first peak signal and a second peak signal that exceed a predefined threshold signal level, the first peak signal and the second signal of each pair of peak signals being separated in time by half of the radio frame.

13. The communication device of claim 12, wherein, in detecting the primary synchronization signal, the processing unit is configured to further perform operations comprising:
determining a reference signal that corresponds to the first peak signal of one of the one or more pairs of peak signals to be the primary synchronization signal; and
determining a half-frame estimate based at least in part on the reference signal that is determined to be the primary synchronization signal.

14. The communication device of claim 12, wherein, in estimating the frequency offset, the processing unit is configured to perform operations comprising:
selecting two peak signals from the one or more pairs of peak signals, the two selected peak signals being adjacent peak signals or being apart from one another by a multiple of one half of the radio frame; and
determining a frequency offset ratio using a spacing in time between the two selected peak signals.

15. The communication device of claim 14, wherein, in determining the frequency offset ratio, the processing unit is configured to determine the frequency offset ratio based at least in part on the following definitions and expressions:
Tᵣₓ=a sampling period at the communication device;
Tₜₓ=a sampling period at the another communication device;
T_{Δ}=a spacing in time between the two selected peak signals;
fᵣₓ=a sampling frequency at the communication device=1/Tᵣₓ;
fₜₓ=a sampling frequency at the another communication device=1/Tₜₓ;
Nᵣₓ=a number of samples taken at the communication device during a time between the two selected peak signals;
Nₜₓ=a number of samples taken at the another communication device during a time between the two selected peak signals;
fₜₓT_{Δ}=Nₜₓ;
fᵣₓT_{Δ}=Nᵣₓ;
Nₜₓ/fₜₓ=Nᵣₓ/fᵣₓ;
fₜₓ/fᵣₓ=Nₜₓ/Nᵣₓ; and
Tₜₓ/Tᵣₓ=Nᵣₓ/Nₜₓ.

16. The communication device of claim 15, wherein the processing unit is configured to synchronize the sample clock timing frequency of the communication device with the sample clock timing frequency of the another communication device based at least in part on the frequency offset ratio.

17. The communication device of claim 16, wherein, in synchronizing, the processing unit is configured to adjust the sampling frequency at the communication device by a factor fₜₓ/fᵣₓ or Tₜₓ/Tᵣₓ.

18. The communication device of claim 15, wherein the estimated frequency offset is expressed as follows:
f_{offfset}=(Nᵣₓ−Nₜₓ)/Nₜₓ, where Nₜₓ=(Nₚₛₛ*N_{rf})/(2*N_{dec}), wherein:
Nₚₛₛ=a number of primary synchronization signal peaks spanned by the communication device in estimating the frequency offset;
N_{rf}=a number of samples in one radio frame; and
N_{dec}=a decimation ratio used in the detecting of the primary synchronization signal.

19. The communication device of claim 11, wherein the receiving unit is configured to receive the wireless communication signal from the another communication device in accordance with the Long-Term Evolution (LTE) standard of a variation thereof.

20. The communication device of claim 1, wherein the processing unit is further configured to synchronize the sample clock timing frequency of the communication device with the sample clock timing frequency of the another communication device based at least in part on the estimated frequency offset.
